(19) United States
(12) Patent Application Publication
(10) Pub. No.: US 2020/0409450 A1
(43) Pub. Date: Dec. 31, 2020

(54) SOFTWARE-CORRELATED SUPPLY VOLTAGES FOR PROCESSING DEVICES

(71) Applicant: Microsoft Technology Licensing, LLC, Redmond, WA (US)

(72) Inventors: William Paul Hovis, Sammamish, WA (US); Gregory M. Daly, Seattle, WA (US); Rich Tat An, Renton, WA (US); Andres Felipe Hernandez Mojica, Seattle, WA (US); Garrett Douglas Blankenburg, Sammamish, WA (US)

(21) Appl. No.: 16/456,664

(22) Filed: Jun. 28, 2019

(51) Int. Cl. G06F 1/3296

(52) U.S. Cl. CPC G06F 1/3296

(57) ABSTRACT

Voltage control arrangements for integrated circuit devices are discussed herein. In one example, a method includes receiving an indication of one or more software elements selected for execution by an integrated circuit device, and determining a target level of a supply voltage for the integrated circuit device based on the indication. The method also includes controlling voltage regulation circuitry to adjust a present level of the supply voltage for the integrated circuit device in accordance with the target level.

### BACKGROUND

Integrated circuit devices, such as central processor devices, graphics processors, or system-on-a-chip (SoC) devices can be employed in computing systems. These integrated circuit devices can have one or more voltage domains which correspond to particular power distribution subdivisions within the integrated circuit device. Power consumption in integrated circuit devices can have a substantial power budget allocated to processing cores, graphics cores, interfacing elements, or various system-on-a-chip (SoC) elements. This power consumption can lead to heat dissipation concerns, especially as operating frequency is increased.

Manufacturers of integrated circuit devices typically specify various minimum operating voltages for the various voltage domains of the integrated circuit devices. However, integrated circuit devices have variability in power consumption due to manufacturing variability, variation in minimum feature sizes, and other factors. This can lead to system integrators to drive integrated circuit devices with unnecessarily high operating voltages, which can increase thermal dissipation and provide artificial limits on operating frequency, and thus limit performance of systems that incorporate such integrated circuit devices.

### OVERVIEW

Voltage control arrangements for integrated circuit devices are discussed herein. In one example, a method includes receiving an indication of one or more software elements selected for execution by an integrated circuit device, and determining a target level of a supply voltage for the integrated circuit device based on the indication. The method also includes controlling voltage regulation circuitry to adjust a present level of the supply voltage for the integrated circuit device in accordance with the target level.

In another example, a voltage control system includes a communication interface configured to receive an indication of one or more software elements selected for execution by an integrated circuit device. The voltage control system also includes a processing system configured to determine at least a target level for a supply voltage of the integrated circuit device based on the indication, and control voltage regulation circuitry to adjust at least the supply voltage for the integrated circuit device in accordance with the target level.

In another example, a system-on-a-chip (SoC) device includes one or more processing cores configured to execute software elements and a control core. The control core is configured to receive indications of target software elements to be executed by the one or more processing cores, and determine, based at least in part on the indications, one or more target voltage levels for at least one voltage domain associated with the one or more processing cores. The control core is configured to indicate to voltage regulation circuitry to adjust voltage levels for the at least one voltage domain in accordance with the one or more target voltage levels.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing system in an implementation.

FIG. 2 illustrates example performance testing in an implementation.

FIG. 3 illustrates example characterization testing in an implementation.

FIG. 4 illustrates example operations of a voltage control system in an implementation.

FIG. 5 illustrates a computing system in an implementation.

FIG. 6 illustrates example operations of a voltage control system in an implementation.

FIG. 7 illustrates an example voltage control system in an implementation.

### DETAILED DESCRIPTION

Computing devices, such as computers, laptops, tables, servers, smartphones, gaming systems, and the like, can have a substantial power budget allocated to main processors, graphics processors, or system-on-a-chip (SoC) elements. As processing demands increase in computing devices, associated power consumption has risen proportionally, leading to difficulties in device packaging, battery life, heat dissipation, fan noise, and speed limitations for associated computing devices. When integrated circuit devices, such as central processing units (CPUs), graphics processing units (GPUs), or system-on-a-chip (SoC) devices, are manufactured, substantial voltage margins are included to account for part-to-part variation, system integration margins, and end-of-life (EoL) margins, among other margins. These margins allow for uniformity and ease of manufacturing testing, but have higher voltages and power consumptions. Operating at higher voltages and power consumptions in integrated circuit devices and associated equipment can lead to increased component stresses and lower component long-term reliability. Integrated circuit devices can also be manufactured using microfabrication processes which shrink feature geometries and produce associated decreases in device capacitance and decreases in operational voltage requirements, which can lead to reductions in power consumption. However, device leakage can become more of a problem with these smaller geometries.

These integrated circuit devices can also include more than one power domain that segregates power consumption among particular portions, such as to particular processing cores or graphics cores each having corresponding voltage level requirements. Throttling of processing devices, such as by reducing/slowing an operating frequency or powering-down selective power domains, can be employed to reduce power consumption and reduce associated temperatures for the computing devices. Some examples of throttling or selective power down include restricting only dynamic (also referred to as “AC”) power by disabling a clock or particular logic function while leaving static power consumption unaffected. Static (also referred to as “DC”) power consumption can be reduced by powering down one or more portions of an integrated circuit device. However, capabilities and performance of the processing devices are typically abridged during these throttling operations. Other power saving techniques are related to providing system-level voltage regulators and power supplies with improved operational efficiencies.

The voltage adjustment techniques herein include at least two different techniques for adjusting operating voltages for integrated circuit devices. A first technique, referred to as a voltage minimization technique, determines minimum operating voltages for a particular integrated circuit device as below manufacturer-specified operating voltages. A second technique, referred to as an execution-optimized technique, determines offsets from the minimum operating voltages on a per-application, per-game, or per-software element basis to establish optimal operating voltages dynamically.

In the voltage minimization techniques, a testing process is performed to exercise an integrated circuit device, such as a system-on-a-chip (SoC) device, in the context of various system components of a computing assembly. These system components can include one or more enclosures, thermal management elements (such as cooling fans, heatsinks, or heat pipes), memory elements (such as random access memory or cache memory), data storage elements (such as mass storage devices), and power electronics elements (such as voltage regulation or electrical conversion circuitry), among others, exercised during functional testing of the integrated circuit device. Moreover, the voltage adjustment techniques herein operationally exercise internal components or portions of an integrated circuit device, such as processing core elements, graphics core elements, north bridge elements, input/output elements, or other elements of the integrated circuit device.

In the execution-optimized techniques, characterization is performed for various software elements that can be executed by the integrated circuit device. These software elements can include applications, games, device drivers, software libraries, entire operating systems, firmware, and other software elements. In some examples, these software elements can include virtualized software elements such as virtual machines, virtual nodes, application containers, Dockers, and other software elements. Moreover, these software elements might include multiple different configurations among individual software elements, such as operating system modes (e.g. safe mode or user mode), hypervisor modes, or versioning of various types of software elements.

The characterization determines voltage offsets from baseline operating voltages for the integrated circuit devices. These voltage offsets can be employed on-the-fly to adjust input voltage levels to an integrated circuit device and either reduce or increase voltage levels accordingly. For example, particular applications or game might operate properly under lower voltage levels than other applications or games. Likewise, some software elements might operate better under higher voltage levels. Each software element executed by a particular integrated circuit device can be characterized to determine associated voltage offsets. Prior to execution or loading by an operating system or other software platform executed on the integrated circuit device, indications of the software elements can be provided to a voltage control system which adjusts input voltage levels to the integrated circuit device. This adjusted voltage levels can advantageously support more tailored execution and voltage delivery on a per-software element basis. Significant power savings can be achieved by tuning voltage levels to be at minimum levels needed to support execution of the software elements. This can lead to lower operating temperatures, support higher operating frequencies for a given operating voltage, reduce power supply component sizing, and reduce thermal management equipment needs.

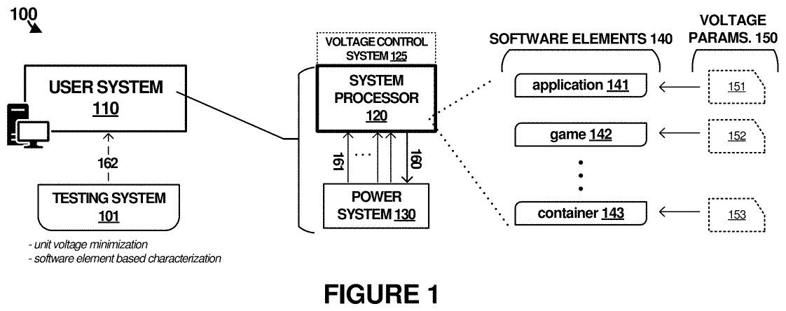

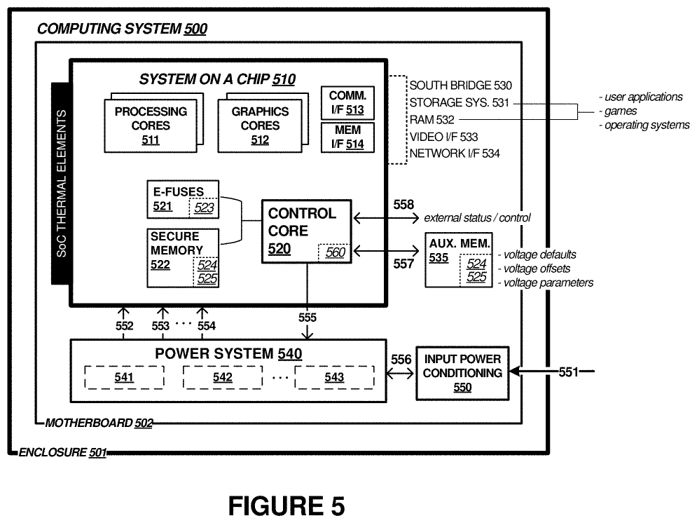

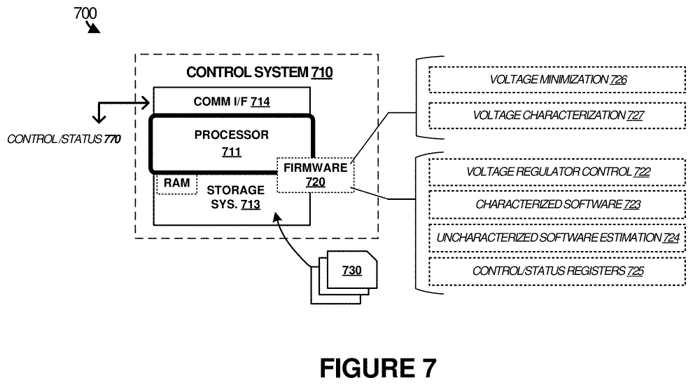

Turning now to the various examples shown in the included drawings, FIG. 1 is presented which illustrates computing environment 100 in an implementation. Computing environment 100 includes user system 110 which can be coupled over one or more communication links to a testing system, such as link 162. Further example systems and elements which can implement the features discussed for user system 110 are included in at least FIG. 5 and FIG. 7 below.

User system 110 includes several components detailed in FIG. 1. These components include system processor 120 and power system 130. System processor 120 can comprise one or more integrated elements, such as processor cores, cache memory, communication interfaces, graphics cores, and north bridge elements, among other integrated elements not shown for clarity. Furthermore, user system 110 can include assembly elements, namely enclosure elements, thermal management elements, memory elements, storage elements, communication interfaces, and graphics interfaces, among other elements not shown for clarity. When system processor 120 is installed in user system 110, these assembly elements provide system resources and context for the operation of system processor 120.

In operation, power system 130 provides one or more input voltages to system processor 120 over links 161. Voltage control system 125 can request the one or more input voltages or change levels of the one or more input voltages over link 160. System processor 120 can then boot into an operating system (OS) once provided with input voltages to provide various operations of user system 110 including user applications, communication services, storage services, gaming services, or other features of a computing system.

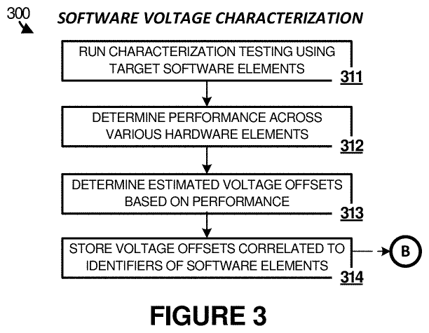

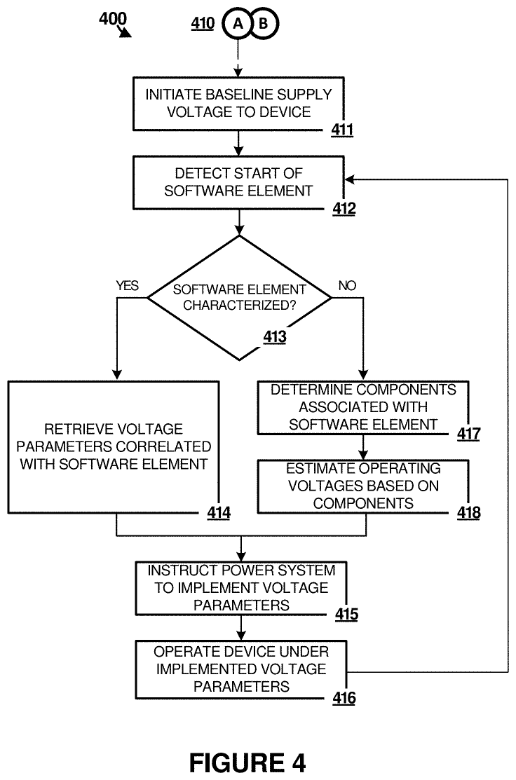

System processor 120 is shown as comprising a plurality of software elements 140. These software elements are merely exemplary in FIG. 1, and include application 141, game 142, and software container 143. As will be discussed in FIGS. 3 and 4, voltage parameters 150 are determined for each individual software element and applied responsive to execution or anticipated execution of the software element by system processor 120. For example, each of software elements 140 can have different voltage parameters associated therewith. These voltage parameters can be retrieved responsive to indications provided by system processor 120 to voltage control system 125. The indications can identify software elements 140 (application 141, game 142, and container 143) for retrieval of associated voltage parameters 151, 152, and 153. Voltage parameters 151, 152, and 153 can then be employed by voltage control system 125 to alter voltage levels provided by voltage regulation elements of power system 130.

In addition to the per-software element characterization techniques, prior voltage minimization techniques can be performed for user device 110. These voltage minimization techniques can be used to establish per-device voltage minimums lower than manufacturer specified operating voltages. Baseline operating voltages based on these voltage minimums are established for system processor 120 which power system 130 applies over links 161 during power-on. Adjustments on a per-software component basis can then be made dynamically.

During manufacture of computing systems that employ an integrated circuit device, a manufacturing test can adjust various voltage settings for a manufacturer-specified operating voltage for the various associated voltage domains or voltage rails of the processing device. When placed into a computing apparatus, such as a computer, server, gaming system, or other computing device, voltage regulation elements use these manufacturer-specified operating voltages to provide appropriate input voltages to the integrated circuit device. Voltage tables can be employed that relate portions of the integrated circuit device to manufacturer-specified operating voltages as well as to specific clock frequencies for those portions. Thus, a hard-coded frequency/voltage (F/V) table is employed in many integrated circuit devices which might be set via fused elements to indicate to support circuitry preferred voltages for different voltage domains and operating frequencies. In some examples, these fused elements comprise voltage identifiers (VIDs) which indicate a normalized representation of the manufacturer-specified operating voltages.

Built-in system test (BIST) circuitry can be employed to test portions of an integrated circuit device, but this BIST circuitry typically only activates a small portion of an integrated circuit device and only via dedicated and predetermined test pathways. Although BIST circuitry can test for correctness/validation of the manufacture an integrated circuit device, BIST circuitry often fails to capture manufacturing variation between devices that still meets BIST thresholds. Manufacturing variations from device to device include variations in metal width, metal thickness, insulating material thickness between metal layers, contact and via resistance, or variations in transistor electrical characteristics across multiple transistor types, and all variations can have impacts on the actual results of power consumption in functional operation. Not only do these structures vary from device to device, but they vary within a device based on normal process variation and photolithography differences that account for even subtle attribute differences in all these structures. As a result, the reduced operating voltages can vary and indeed may be unique on each integrated circuit device. BIST also typically produces a pass/fail result at a specific test condition. This test condition is often substantially different from real system operation for performance (and power) such that it does not accurately represent system power and performance capability of the integrated circuit device. With large amounts of variability between a BIST result and a functional result, the voltages employed by BIST may be found sufficient for operation but might employ significant amounts of voltage margin. In contrast to BIST testing, the functional tests described herein employ functional patterns that activate not only the entire processing device but also other components of the contextually-surrounding system that may share power domains or other elements with the integrated circuit device.

In the examples herein, functional tests are employed to determine reduced operating voltages (Vmins) for an integrated circuit device, such as a system-on-a-chip (SoC) devices, graphics processing units (GPUs), or central processing units (CPUs). These functional tests run system-level programs which test not only an integrated circuit device, but the entire computing system in which the integrated circuit device is installed. Targeted applications can be employed which exercise the computing system and the integrated circuit device to ensure that particular processing units within the integrated circuit device are properly activated. This can include ensuring that all portions of the integrated circuit device are activated fully, a subset of units activated fully, or specific sets of background operations active in combination with targeted power-consuming operations.

In a specific example, an SoC is employed in a computing system. The SoC can comprise a central processing unit (CPU) with one or more processing cores, a graphics processing unit (GPU) with one or more graphics cores, a north bridge which handles communication between various cores, integrated memory, and off-SoC memory.

Input/output portions are also included in the SoC to allow for communication with universal serial bus (USB) ports, peripheral component interconnect express (PCIe) links, mass storage interfaces, networking interfaces such as Ethernet or wireless networking, user interface devices, game controllers, and other devices communicatively coupled to the SoC. Multiple power domains can be employed in the SoC, such as a first one for the processing cores, a second one for the north bridge, and a third one for the graphics cores, among others. Each of these cores can be functionally tested in parallel to ensure traffic propagation and logical activation across core boundaries comprising both clock and voltage boundaries.

The functional tests for CPU portions can include operations initiated simultaneously on all the processing cores (or a sufficient number of them to represent a ‘worst’ possible case that a user application might experience) to produce both static/DC power demand and dynamic/AC power demand for the processing cores that replicates real-world operations. Distributed checks can be provided, such as watchdog timers or error checking and reporting elements built into the integrated circuit device, and are monitored or report alerts if a failure, crash, or system hang occurs. A similar approach can be used for the GPU, where the functional test ensures the GPU and associated graphics cores focus on high levels of graphic rendering activity to produce worst case power consumption (DC and AC), temperature rises, on-chip noise, and a sufficient number of real data paths which produce accurate operational Vmins. North bridge testing can proceed similarly, and also include memory activity between off-device memory devices and on-chip portions that are serviced by those memory devices.

The power reduction using voltage adjustment processes herein can employ voltage regulation modules (VRMs) or associated power controller circuitry with selectable voltage supply values (such as in increments of 12.5 mV, 6.25 mV, 3.125 mV, and the like), where the integrated circuit device communicates with the VRMs or associated power controller circuitry to indicate the desired voltage supply values during an associated power/functional test or state in which the processing device may be operating.

Once reduced voltage values have been determined, the integrated circuit device can receive input voltages set to a desired reduced value from associated VRMs. This allows input voltages for integrated circuit devices to be set below manufacturer specified levels, leading to several technical effects. For example, associated power savings can be significant, such as 20-50 watts in some examples or 30% in other cases, and cost savings can be realized in the design and manufacturing of reduced capacity system power supplies, reductions in the VRM specifications for the integrated circuit devices, cheaper or smaller heat sinks and cooling fans. Smaller system enclosures or packaging can be employed. Additionally, the power savings can result in system characteristics that reduce electrical supply demands or battery drain.

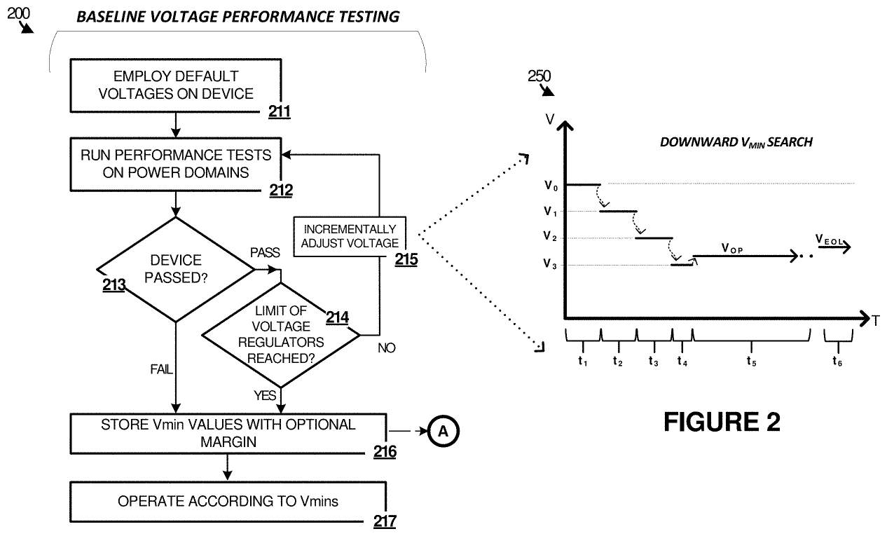

FIG. 2 is included to illustrate operation of an example voltage minimization process. Specifically, FIG. 2 is a flow diagram illustrating a method of operating elements of computing environment 100 in an implementation. The voltage minimization process discussed in FIG. 2 allows system processor 120 or associated user system 110, in concert with testing system 101, to determine appropriate reduced input voltages for system processor 120, resulting in power savings for user system 110.

FIG. 2 is included to illustrate operation of performance testing to determine performance properties of integrated circuit devices in computing systems. Specifically, FIG. 2 is a flow diagram illustrating a method of operating elements of voltage control circuitry in an implementation. This voltage control circuitry can comprise elements of voltage control system 125 and power system 130 in FIG. 1. Similar techniques and processes can be applied to control core 520 and power system 540 in FIG. 5, and control system 710 in FIG. 7. In FIG. 2, a performance test is executed for a target integrated circuit device, such as system processor 120 in FIG. 1. For purposes of example, the operations below are executed in context with user system 110, system processor 120, and power system 130.

This performance test can be initiated by testing system 101 or voltage control system 125 and executed by processing cores or processing elements of system processor 120. System processor 120 is typically booted into an operating system to run the performance testing of FIG. 2. During execution of the performance test on system processor 120, supply voltages will be incrementally adjusted by voltage control system 125 and power system 130 to determine minimum functional operating voltage levels. In one example, this performance test includes incrementally adjusting at least one supply voltage by initially operating one or more voltage domains of system processor 120 at a first supply voltage lower than a manufacturer specified operating voltage and progressively lowering the supply voltage in predetermined increments while performing the functional test and monitoring for occurrence of the operational failures. In another example, this performance test includes incrementally adjusting at least one supply voltage by initially operating one or more voltage domains of system processor 120 at a first supply voltage lower than a manufacturer specified operating voltage and progressively raising the supply voltage in predetermined increments while performing the functional test and monitoring for occurrence of the operational failures.

In manufacturing operations, a computing system comprising system processor 120 is built and then tested individually according to a performance test. After the performance test has characterized system processor 120 for minimum operating voltage plus any applicable voltage margin, system processor 120 can be operated normally using these voltages. This performance test determines minimum supply voltages for proper operation of system processor 120, which also relates to a power consumption of system processor 120. Voltage is related to power consumption by Ohm's law and Joule's first law, among other relationships, and thus a lower operating voltage typically corresponds to a lower operating power for system processor 120. Power consumption relates to an operating temperature, giving similar workloads for system processor 120. Thus, the voltage adjustment method discussed in FIG. 2 allows power control circuitry to determine appropriate reduced input voltages for system processor 120, resulting in power savings for user system 110.

A processing device, such as system processor 120 of FIG. 1, is incorporated into a computing system, such as user system 110. System processor 120 also includes many contextual assembly elements, which might include a south bridge, storage elements, video interfaces, random-access memory, and network interfaces. In many examples, system processor 120 is installed into user system 110 during a system assembly process before testing and further assembly. Thus, the hardware and software elements included in user system 110 are typically the actual contextual elements for operating system processor 120 once installed into a computing system.

Voltage control system 125 initially employs (211) default voltages to provide power to system processor 120. For example, voltage control system 125 can instruct power system 130 over link 160 to provide input voltages over associated power links 161 according to manufacturer-specified operating voltages, which can be indicated by VID information retrieved by voltage control system 125. In other examples, such as when progressively rising voltages are iteratively provided to system processor 120, the default voltages can comprise a starting point from which to begin raising voltage levels over time. In examples that employ incrementally rising voltages, starting voltages might be selected to be sufficiently low enough and less than those supplied by a manufacturer. Other default voltage levels can be employed. Once the input voltages are provided, system processor 120 can initialize and boot into an operating system or other functional state.

An external system, such as testing system 101, might transfer one or more functional tests for execution by system processor 120 after booting into an operating system. Testing system 101 can transfer software, firmware, or instructions to voltage control system 125 or system processor 120 over link 162 to initiate one or more functional tests of system processor 120 during a voltage adjustment process. These functional tests can be received over a communication interface of system processor 120 and can comprise performance tests that exercise the various integrated elements of system processor 120 as well as the various contextual assembly elements of system processor 120. Portions of the voltage adjustment process or functional tests can be present before boot up to adjust input voltages for system processor 120, such as by first initializing a first portion of system processor 120 before initializing second portions.

Once system processor 120 can begin executing the functional tests, voltage control system 125 drives one or more performance tests for each of the power domains (212) of system processor 120. These power domains can include different input voltages and different input voltage levels. The functional tests can exercise two or more of the power domains simultaneously, which might further include different associated clock signals to run associated logic at predetermined frequencies. The functional tests can include operations initiated simultaneously on more than one processing core to produce both static/DC power demand and dynamic/AC power demand for the processing cores, graphics cores, and interfacing cores that replicates real-world operations. Moreover, the functional tests include processes that exercise elements of system processor 120 in concert with contextual elements of user system 110, which might include associated storage devices, memory, communication interfaces, thermal management elements, or other elements.

The performance tests will typically linger at a specific operating voltage or set of operating voltages for a predetermined period of time, as instructed by any associated control firmware or software. This predetermined period of time allows for sufficient execution time for the functional tests to not only exercise all desired system and processor elements but also to allow any errors or failures to occur. The linger time can vary and be determined from the functional tests themselves, or set to a predetermined time based on manufacturing/testing preferences. Moreover, the linger time can be established based on past functional testing and be set to a value which past testing indicates will capture a certain population of errors/failures of system processors in a reasonable time.

If system processor 120 does not experience failures or errors relevant to the voltage adjustment process during the linger time, then the specific input voltages employed can be considered to be sufficiently high to operate system processor 120 successfully (213). Thus, the particular iteration of input voltage levels applied to system processor 120 is considered a ‘pass’ and another progressively adjusted input voltage can be applied. As seen in operation (215) of FIG. 2, input voltages for system processor 120 can be incrementally lowered, system processor 120 restarted, and the functional tests executed again for the linger time. A restart of system processor 120 might be omitted in some examples, and further operational testing can be applied at a new voltage level for each linger timeframe in a continuous or repeating manner. This process is repeated until either lower limits of voltage adjustment circuitry, such as voltage regulators, associated with power system 130 have been reached (214), or relevant failures of system processor 120 or contextual components of user system 110 are experienced. This process is employed to determine reduced operating voltages for system processor 120 in the context of the assembly elements of user system 110. Once voltage adjustments for the associated power domains are found, indications of these voltage adjustments can be stored for later use at voltage ‘minimums’ (Vmins) in operation 216, optionally with margins appropriate for operational ‘safety’ to reduce undiscovered failures or errors during the functional testing. These voltage minimums and optional margins can be used to establish baseline operating voltages for system processor 110.

The functional tests can comprise one or more applications, scripts, or other operational test processes that bring specific power domains up to desired power consumption and operation, which may be coupled with ensuring that system processor 120 is operating at preferred temperature as well. These functional tests may also run integrity checks (such as checking mathematical computations or checksums which are deterministic and repeatable). Voltages provided by power system 130 to system processor 120, as specified by an associated performance test control system and communicated to voltage control system 125, can be lowered one incremental step at a time and the functional tests run for a period of time until a failure occurs. The functional tests can automatically handle all possible failure modes resulting from lowering the voltage beyond functional levels. The possible failures include checksum errors detected at the test application level, a kernel mode crash detected by the operating system, a system hang, or hardware errors detected by system processor resulting in “sync flood” error mechanisms, among others. All failure modes can be automatically recovered from for further functional testing. To enable automatic recovery, a watchdog timer can be included and started in a companion controller, such as a “System Management Controller” (SMC), Embedded Controller, voltage control system 125, or other control circuitry. The functional tests can issue commands to the companion controller to initialize or reset the watchdog timer periodically. If the watchdog timer expires or system processor 120 experiences a failure mode, the companion controller can perform a system reset for user system 110 or system processor 120. Failure modes that result in a system reset can prompt voltage control system 125 to initialize system processor 120 with ‘default’ or ‘known good’ voltage levels from power system 130. These default levels can include manufacturer specified voltages or include voltage levels associated with a most recent functional test ‘pass’ condition.

Once system processor 120 initializes or boots after a failure during the functional tests, the failure can be noted by a failure process in the functional tests or by another entity monitoring the functional tests, such as a performance test control system or manufacturing system. The voltage level can then be increased a predetermined amount, which might comprise one or more increments employed during the previous voltage lowering process. The increase can correspond to 2-3 increments in some examples, which might account for test variability and time-to-fail variability in the functional tests.

The voltage values determined from the voltage adjustment process can be stored (216) by voltage control system 125 into a memory device or data structure along with other corresponding information, such as time/date of the functional tests, version information for the functional tests, or other information. Voltage control system 125 might store these voltage values in memory or in one or more data structures which indicate absolute values of voltage values or offset values of voltage values from baseline voltage values. Voltage control system 125 might communicate the above information to an external system over link 162, such as a manufacturing system or performance test control system represented by testing system 101. Other stored information can include power consumption peak values, average values, or ranges, along with ‘bins’ into which each computing module is categorized. Stored voltage information can be used during power-on operations of user system 110 to establish voltage levels (217) to be provided by voltage control system 125 to voltage adjustment units of power system 130. The resulting computing module characteristics (e.g. power levels and thermal attributes) are substantially improved after the voltage adjustment process is completed. Thus, the voltage adjustment process described above allows systems to individually determine appropriate reduced operating voltages during a manufacturing or integration testing process, and for testing performed in situ after manufacturing occurs. Testing can be performed to determine changes in minimum operating voltages after changes are detected to system processor 120, contextual elements, or periodically after a predetermined timeframe.

The iterative voltage search procedure can be repeated independently for each power domain and for each power state in each domain where power savings are to be realized. For example, a first set of functional tests can be run while iteratively lowering an input voltage corresponding to a first voltage/power domain of system processor 120. A second set of functional tests can then be run while iteratively lowering a second input voltage corresponding to a second voltage/power domain of system processor 120. When the second set of functional tests are performed for the second input voltage, the first voltage can be set to a value found during the first functional tests or to a default value, among others.

Advantageously, end-of-life (EoL) voltage margin need not be added during manufacturing test or upon initial shipment of user system 110. EoL margin can be added if desired, such as 10 to 50 millivolts (mV), among other values, or can be added after later in-situ testing described below. EoL margins are typically added in integrated circuit systems to provide sufficient guardband as associated silicon timing paths in the integrated circuit slow down over time with use. Although the amount of margin typically employed for EoL is only perhaps 15-30 mV (depending upon operating conditions, technology attributes, and desired life time), the systems described herein can eliminate this margin initially, either partially or entirely. In some examples, an initial voltage margin is employed incrementally above the Vmin at an initial time, and later, as the system operates during normal usage, further EoL margin can be incrementally added proportional to the total operational time (such as in hours) of a system or according to operational time for individual voltage domains. Thus, extra voltage margin is recovered from system processor 120 after the initial voltage adjustment process, and any necessary margin for EoL can be staged back over the operational lifetime of system processor 120. Moreover, by operating a user system at lower voltages for a longer period of time, system reliability is further improved. These benefits might taper off over the course of time as the EoL margin is staged back in, but it will improve the initial experience.

FIG. 2 also illustrates graph 250 that show how a voltage adjustment process might progress. Graph 250 can illustrate one example voltage minimization operation for operation 215 of FIG. 2. Graph 250 shows a ‘downward’ incremental Vmin search using progressively lowered voltages, with safety margin added at the end of the process to establish an operational voltage, V_{OP}. V_{OP} can comprise a baseline operating voltage discussed herein, although variations are possible including later addition of margins for EoL or safety. Later margin (V_{EOL}) can be staged in to account for EoL concerns. Specifically, graph 250 shows a default or initial voltage level V₀ applied to system processor 120. After a linger time for a functional test, a successful outcome prompts an incremental lowering to V₁ and retesting under the functional test. Further incremental lowering can be performed for each successful iteration of the functional test for an associated time indicated in graph 250. Finally, a lowest or reduced operating voltage is found at V₃ and optional margin is applied to establish V_{OP}. V_{OP} is employed for the normal operation of the system processor for a period of operational time indicated by t₅. This time can occur while an associated system is deployed on-site. After a designated number of hours indicated by t₅, EoL margin can be staged in to established V_{EOL}. Multiple stages of EoL margin can occur, although only one is shown in graph 250 for clarity.

The voltage levels indicated in graph 250 can vary and depend upon the actual voltage levels applied to a system processor. For example, for a voltage domain of system processor 120 operating around 0.9V, a reduced voltage level can be discovered using the processes in graph 250. Safety margin of 50 mV might be added in graph 250 to establish V_{OP} and account for variation in user applications and device aging that will occur over time. However, depending upon the operating voltage, incremental step size, and aging considerations, other values could be chosen. In contrast to the downward voltage search in graph 250, an upward voltage search process can instead be performed. An upward voltage search process uses progressively raised voltages to establish an operational voltage, V_{OP}. Later margin (V_{EOL}) can be staged in to account for EoL concerns.

The processes in graph 250 can be executed independently for each power supply or power domain associated with system processor 120. Running the procedure on one power supply or power domain at a time can allow for discrimination of which power supply or power domain is responsible for a system failure when looking for the Vmin of each domain. However, lowering multiple voltages for power supplies or power domains at the same time can be useful for reducing test times, especially when failure can be distinguished among the various power supplies or power domains. In further examples, a ‘binary’ voltage adjustment/search algorithm can be used to find the Vmin by reducing the voltage halfway to an anticipated Vmin as opposed to stepping in the increments of graph 250. In such examples, a Vmin further testing might be needed by raising the voltage once a failure occurred and successfully running system tests at that raised value. Other voltage adjustment/search techniques could be used and the techniques would not deviate from the operations to establish a true Vmin in manufacturing processes that can then be appropriately adjusted to provide a reasonable margin for end user operation.

Turning now to a discussion on per-software element voltage adjustment, FIG. 3 is presented. FIG. 3 illustrates example method 300 of performing characterization based on software elements executed by an integrated circuit device, such as system processor 120. The operations of FIG. 3 are in the context of elements of FIG. 1, although other elements can be employed. The characterization process of FIG. 3 results in voltage offsets for supply voltages of system processor 120 which are correlated to various software elements that can be executed by system processor 120. Representations of the voltage offsets can be stored in a data structure in relation to identities of the software elements for usage during operation of user system 110.

In FIG. 3, a characterization test might be performed on user system 110 itself or might instead be performed on other representative computing systems similar to user system 110. For example, a characterization test might be performed over a sampling of user systems with similar configurations as user system 110 to determine an average or statistically relevant behavior of various software elements. Although user system 110 might be employed in these characterization tests, it should be understood that these characterization tests may instead be performed during a manufacturing phase, a qualification phase, or on an ongoing basis to determine voltage offsets on a per-software component basis across one or more representative user systems.

The level of granularity with regard to which software elements are characterized can vary by implementation. For example, the granularity of characterization can be on a per-application or per-game basis. This level of granularity might be sufficient for user systems which have a pre-set suite of applications or games installed thereon. When users can install new or different applications or games, then the characterization might not capture these new software elements. In some examples, the new software elements, such as applications/games, might be accompanied by characterized voltage offsets during download or install. In other examples, a finer granularity on software characterization can be performed which considers not only the application or game, but also individual software elements which comprise the software or game. These individual software elements can include shared software libraries, device drivers, or configurations and versions of particular software elements. Moreover, instead of applications or games, other types of software elements can be characterized, as discussed herein, which can include software containers, virtual machines, Docker elements, disk images, operating system types/versions, or other software elements.

In further examples, characterization can be performed to determine what hardware elements are employed during execution of various software elements, such as active processing cores, graphics cores, communication interfaces, peripherals, and other hardware elements. Voltage offsets can be determined on a per-hardware component basis in addition to a per-software component basis. Other per-component characterizations can be employed which span both hardware and software, such as execution threads, memory usage, storage usage, or network usage, among others. These voltage offsets can thus form a large listing of hardware and software components which might be employed during execution of various software elements (such as applications). When an application is executed, or about to be executed, an indication of these hardware/software components can be delivered to voltage control system 125 for selection of one or more voltage offsets. When more than one voltage offset is selected based on indications of more than one hardware/software component, then voltage control system 125 can combine, add, or otherwise calculate net voltage offsets for each affected voltage domain. In this manner, both characterized applications and uncharacterized applications can be handled by voltage control system 125 based on the underlying hardware/software components which are employed during execution of the applications.

Turning now to the operations of FIG. 3, testing system 101 can execute (311) characterization testing using target software elements. As discussed above, this characterization testing characterizes performance of software elements, such as applications, games, and sub-components across one or more user systems representative of user system 110. During the characterization testing, testing system 101 can determine (312) performance of the software elements across one or more user systems representative of user system 110. This performance can include power consumption and dynamic performance across various processing cores and other hardware elements for the representative user systems. These hardware elements can include processing cores, graphics cores, interfacing elements, and on-die cache memory elements for a system processor, such as a CPU, GPU, or SoC device. The characterization process can execute software elements over various performance regimes, such as over voltage minimums (Vmins) for associated voltage/power domains, operational modes, workloads, and other conditions to determine maximum power consumptions, average power consumptions, noise characteristics, changes in current draws over time (e.g. di/dt performance), coupling, or the timing of signal paths with regard to various noise events, among other characteristics. The characterization process can also execute software elements, such as applications and sub-components, to characterize Vmin values for each test system. This characterization of Vmins for each test system can also be used to determine performance of the application or software components based on variations in resultant Vmins. Vmin adjustments from a baseline Vmin might be determined by executing the applications and software components across a variety of test systems.

Testing system 101 determines (313) estimated voltage offsets based on the performance noted above. Each software element, such as application or game, can have different power consumptions and dynamic performance characteristics during usage. This power consumption can translate into preferred voltage levels supplied to a system processor which executes the application or game, among other software elements. Typically, higher power consumptions relate to higher operating voltage for a given supply voltage of a system processor. Thus, an estimation of voltage offsets from baseline operating voltages can be determined based on power consumption for the particular software element. Each voltage offset can be quantified using various estimation methods to scale a baseline voltage according to a corresponding power consumption for each characterized application or game. Sub-component characterization can also be performed on software/hardware components which comprise each characterized application/game. Thus, voltage offsets can be determined on a per-application, per-game, or per-subcomponent basis, among other arrangements.

Once the voltage offsets are determined, testing system 101 stores (314) the voltage offsets correlated to identifiers of software elements. Representations of the voltage offsets can be stored in one or more data structures in relation to identities of the software elements for usage during operation of user systems. These one or more data structures might comprise any suitable types, such as tables, databases, or other types. The data structures can be represented in FIG. 1 as voltage parameters 150 which are related or correlated to software elements 140. Testing system 101 or another system can transfer the data structures to user system 110 for use during operation of user system 110. These data structures can be delivered in part or in whole upon manufacture, responsive to installation of corresponding software elements (whether during manufacture or after present at user sites), or periodically updated.

To utilize both the voltage minimization techniques and software element based characterization from FIGS. 2-3, operation of user system 110 is presented in FIG. 4. FIG. 4 illustrates operation of voltage control system 125 in user system 110. Prior to the operation 400 of FIG. 4, various operations of FIGS. 2-3 can be performed as indicated by initial step 410 and markers ‘A’ and ‘B’.

In FIG. 4, voltage control system 125 initiates (411) baseline supply voltages for processing device 120. These baseline supply voltages can be applied to processing device 120 over links 161 by power system 130, as instructed by voltage control system 125 over link 160. Link 160 might comprise system management bus (SMB) interfaces, inter-integrated circuit (I2C) interfaces, or other suitable communication interfaces. Once the baseline supply voltages have been applied, then processing device 120 can boot into an operating system, and begin executing software elements, such as user applications, games, and other such software.

As discussed herein, the baseline supply voltages can be determined using a voltage minimization techniques or voltage optimization techniques seen in FIG. 2. For example, a Vmin value lower than a manufacturer specified minimum operating voltage can be determined for a particular voltage domain of system processor 120 for user system 110. This Vmin might be augmented by one or more margins to account for EoL or other factors, and the resultant voltage level can be established as a baseline supply voltage for that voltage domain of system processor 120. Similar processes can occur for other voltage domains of system processor 120. These Vmin values or baseline supply voltage levels can be stored local to system processor 120 for later retrieval by voltage control system 125. FIG. 5 illustrates one example system for storing and retrieving Vmin values and baseline supply voltage levels. Upon power-on of user system 110, and before booting of processing cores or operating systems of system processor 120, voltage control system 125 can determine the baseline supply voltages and instruct power system 130 to adjust default voltages accordingly.

After boot of system processor 120 into an operating system, voltage control system 125 detects (412) a start of one or more software elements. This detection can be by monitoring software executed by processing cores of system processor 120, or by indication of the one or more software elements by the operating system or other telemetry elements hosted on the one or more processing cores. Voltage control system 125 processes any received indication or monitored identity of software elements being executed, predicted to be executed, or scheduled to be executed by system processor 120 and determines if the software elements have been previously characterized (413) or are uncharacterized. Previously characterized software elements might have entries in a data structure maintained by voltage control system 125 which indicate corresponding voltage parameters for adjusting a supply voltage provided to system processor 120. Uncharacterized software elements might either prompt no voltage adjustment, or instead voltage control system 125 might determine estimated or predicted voltage parameters based on various factors.

When the software elements have been previously characterized, such as detailed in FIG. 3, then voltage control system 125 can retrieve (414) voltage parameters correlated with software elements from a data structure or storage device. The voltage parameters might comprise voltage parameters 150 of FIG. 1 which can be individually associated with software elements 140. The voltage parameters might comprise voltage offsets from reference voltage levels such as baseline operating voltage or baseline supply voltage, or might instead comprise voltage levels themselves which can be applied to control voltage regulation elements. The voltage levels can comprise any suitable representation, such as digital or binary representations of voltage levels, voltage identifiers (VIDs), or other representations within one or more data structures. Voltage offsets might be positive or negative offsets, and the ‘sign’ or polarity of the voltage offsets can be indicated using one or more digital or binary representations. In one example of a characterized software element, the software element to be executed by system processor 120 can comprise an application. An indication of the application can be transferred by an operating system or other execution element of system processor 120 for receipt by voltage control system 125. Voltage control system 125 can then use this identifier as a lookup key in a data structure that has voltage parameters stored for the application.

When the software elements have not been previously characterized, then default or baseline voltage levels might be employed. Alternatively, a multi-step follow-up process might instead be employed. First, voltage control system 125 can determine (417) individual components associated with the software element or software elements to be executed by system processor 120. Indicators of the individual components can be transferred by execution elements of system processor 120. These individual components can include various hardware components used to execute the software elements, or various software elements that comprise the software elements or aid in execution of the software elements. For example, an application or game might be uncharacterized, but might employ one or more device drivers that implicate various hardware components, or might be formed by one or more software libraries or software modules which are executed using one or more processing cores, graphics cores, or other elements of system processor 120. Voltage control system 125 can then at least partially estimate (418) preferred operating voltage levels based on these implicated hardware or indicated software components. This estimation might include adding or combining voltage parameters for many different software or hardware components which have been previously characterized in a granular process that establishes voltage parameters for each component. Since these voltage parameters might comprise voltage offsets, then each voltage offset can be added or combined to determine a net or summation value of the voltage offset. This net voltage offset can be employed by voltage control system 125 to control voltage levels produced by power system 130.

Once the voltage parameters have been determined, such as the voltage offset or absolute value of a voltage, then voltage control system 125 instructs (415) power system 130 to implement the voltage parameters. This instruction can comprise commands or control signaling which indicates to voltage regulation elements of power system 130 to alter or adjust a present voltage level in accordance with the commands or control signaling. Voltage control system 125 might determine VIDs for transfer to power system 130 which uses these VIDs to alter or adjust present voltage levels in accordance with the VIDs. Once implemented by power system 130, system processor 120 operates (416) under the implemented voltage parameters, such as by executing the software elements which drove the adjustments to voltage levels discussed above.

Returning to the elements of FIG. 1, testing system 101 comprises a platform from which a voltage adjustment process discussed in FIG. 2 is staged, and failures or successes of the functional tests are monitored. Testing system 101 can include communication interfaces, network interfaces, processing systems, computer systems, microprocessors, storage systems, storage media, or some other processing devices or software systems, and can be distributed among multiple devices or across multiple geographic locations. Examples of testing system 101 can include software such as an operating system, logs, databases, utilities, drivers, networking software, and other software stored on a computer-readable medium. Testing system 101 can comprise one or more platforms which are hosted by a distributed computing system or cloud-computing service. Testing system 101 can comprise logical interface elements, such as software defined interfaces and Application Programming Interfaces (APIs).

User system 110 and testing system 101 can communicate over one or more communication links 162. In some examples, communication link 162 comprises one or more network links, such as wireless or wired network links. Other configurations are possible with elements of user system 110 and testing system 101 communicatively coupled over various logical, physical, or application programming interfaces. Example communication links can use metal, glass, optical, air, space, or some other material as the transport media. Example communication links can use various communication interfaces and protocols, such as Internet Protocol (IP), Ethernet, USB, Thunderbolt, Bluetooth, IEEE 802.11 WiFi, or other communication signaling or communication formats, including combinations, improvements, or variations thereof. Communication links can be direct links or may include intermediate networks, systems, or devices, and can include a logical network link transported over multiple physical links.

User system 110 comprises a computing system or computing assembly, such as a computer, server, tablet device, laptop computer, smartphone, gaming system, entertainment system, storage system, or other computing system, including combinations thereof. User system 110 includes system processor 120 and voltage control system 125. Furthermore, user system 110 can include assembly elements, namely enclosure elements, thermal management elements, memory elements, storage elements, communication interfaces, and graphics interfaces, among other elements not shown for clarity. When system processor 120 is installed in user system 110, these assembly elements provide system resources and context for the operation of system processor 120. Enclosure elements can include structural support elements, cases, chassis elements, or other elements that house and structurally support the further elements of user system 110. Thermal management elements can include heatsinks, fans, heat pipes, heat pumps, refrigeration elements, or other elements to manage and control temperature of user system 110. Memory elements can comprise random-access memory (RAM), cache memory devices, or other volatile memory elements employed by system processor 120. Storage elements comprise non-volatile memory elements, such as hard disk drives (HDDs), flash memory devices, solid state drives (SSDs), or other memory devices which store operating systems, applications, or other software or firmware for user system 120. Communication interfaces can include network interfaces, peripheral interfaces, storage interfaces, audio/video interfaces, or others which communicatively couple user system to external systems and devices. Graphics interfaces can include display interfaces, displays, touchscreens, touch interfaces, user interfaces, among others.

System processor 120 can comprise one or more large-scale integrated circuit devices including general purpose processors, application specific processors, and integrated logic devices, as well as any other type of processing device, including combinations or variations thereof. Examples of system processor 120 include central processing units (CPUs), graphics processing units (GPUs), system-on-a-chip (SoC) devices, or other integrated circuit devices which can execute user software. System processor 120 can comprise one or more processor cores, graphics cores, control cores, security cores, cache memories, communication interfaces, and north bridge elements, among other integrated elements not shown for clarity. In some examples, system processor 120 comprises an Intel® microprocessor, AMD® microprocessor, ARM® microprocessor, field-programmable gate array (FPGA), or other similar device.

Voltage control system 125 might be included in elements of system processor 120, or may be separate from system processor 120. Voltage control system 125 can comprise one or more microprocessors and other processing circuitry. Voltage control system 125 can retrieve and execute software or firmware comprising voltage control firmware, voltage monitoring firmware, and voltage optimization or minimization firmware from an associated storage system. Voltage control system 125 can be implemented within a single processing device but can also be distributed across multiple processing devices or sub-systems that cooperate in executing program instructions. Examples of voltage control system 125 include general purpose central processing units, application specific processors, and logic devices, as well as any other type of processing device, combinations, or variations thereof. In some examples, voltage control system 125 comprises a processing core separate from processing cores that execute user software for system processor 120, such as a hardware security module (HSM), hardware security processor (HSP), security processor (SP), trusted zone processor, trusted platform module processor, management engine processor, microcontroller, microprocessor, FPGA device, application specific integrated circuit (ASIC) device, application specific processor, or other processing elements.

Power system 130 typically includes voltage regulator circuitry, DC-DC conversion circuitry, controller circuitry, power filtering elements, power conditioning elements, power conversion elements, power electronics elements, or other power handling and regulation elements. Power system 130 receives power from an external source, such as from batteries or an external power source, and converts/regulates the power to produce voltages and currents to operate the elements of user system 110. Power system 130 might comprise a multiphase power supply. The total quantity of power phases can vary by implementation. Elements of power system 130 might be replicated a number of times to provide several voltages for system processor 120 or multiple system processors, such as when system processor 120 requires different voltages applied to different voltage domains. A separate instance of power system 130 might be employed for each voltage domain, with some control elements optionally shared among instances. Power system 130 receives power from an external source, such as from batteries or an external power source, and converts/regulates the power to produce voltages and currents to operate the elements of user system 110. In FIG. 1, power system 130 converts an input power source into one or more supply voltages. Power system 130 provides supply voltages to system processor 120 over power links 161.

As a further example of voltage control within example computing environments and systems, FIG. 5 is presented. FIG. 5 illustrates computing system 500 that is representative of any system or collection of systems in which the various operational architectures, platforms, scenarios, and processes disclosed herein may be implemented. For example, computing system 500 can be used to implement any of the integrated circuit devices discussed herein, such as system processor 120 and user system 110 of FIG. 1, among others.

Examples of computing system 500 include, but are not limited to, a gaming console, smartphone, tablet computer, laptop, server, personal communication device, personal assistance device, wireless communication device, subscriber equipment, customer equipment, access terminal, telephone, mobile wireless telephone, personal digital assistant, personal computer, e-book, mobile Internet appliance, wireless network interface card, media player, or some other computing apparatus, including combinations thereof.

Computing system 500 may be implemented as a single apparatus, system, or device or may be implemented in a distributed manner as multiple apparatuses, systems, or devices. Computing system 500 includes, but is not limited to, motherboard 502, system on a chip (SoC) device 510, and power system 540. Various contextual or peripheral elements can be included in computing system 500, such as mounted to motherboard 502 or included on separate circuit boards. These elements include south bridge 530, storage system 531, video interfaces 513, random-access memory (RAM) 532, network interfaces 534, and auxiliary memory 535. Furthermore, input power conditioning circuitry 550 and optional thermal management elements can be included. SoC device 510 can be optionally mounted to a carrier circuit board instead of directly to motherboard 502.

Referring still to FIG. 5, SoC device 510 may comprise a micro-processor and processing circuitry that retrieves and executes software from storage system 531 and RAM 532. Software can include various operating systems, user applications, gaming applications, multimedia applications, or other user applications. SoC device 510 may be implemented within a single processing device, but may also be distributed across multiple processing devices or sub-systems that cooperate in executing program instructions. Examples of SoC device 510 include general purpose central processing units, application specific processors, graphics processing units, and logic devices, as well as any other type of processing device, combinations, or variations thereof. In FIG. 5, SoC device 510 includes processing cores 511, graphics cores 532, communication interfaces 513, memory interfaces 514, control core 520, electronic fuses (e-fuses) 521, and secure memory 522, among other elements. Some of the noted elements of SoC device 510 can be included in a north bridge portion of SoC device 510. Elements of control core 520, e-fuses 521, and secure memory 524 might be included in circuitry external to SoC device 510. SoC device 510 is operatively coupled with other elements in computing system 500 external to SoC device 510, such as south bridge 530, storage system 531, video interfaces 513, RAM 532, network interfaces 534, and auxiliary memory 535.

Data storage elements of computing system 500 include storage system 531 and RAM 532. Storage system 531 and RAM 532 may comprise any computer readable storage media readable by SoC device 510 and capable of storing software. Storage system 531 and RAM 532 may include volatile and nonvolatile, removable and non-removable media implemented in any method or technology for storage of information, such as computer readable instructions, data structures, program modules, or other data. Examples of storage media include dynamic random access memory (DRAM), static random access memory (SRAM), read only memory, magnetic disks, optical disks, flash memory, virtual memory and non-virtual memory, magnetic disk storage or other magnetic storage devices, or any other suitable storage media. Storage system 531 may comprise additional elements, such as a controller, capable of communicating with SoC device 510 or possibly other systems.

South bridge 530 includes interfacing and communication elements which can provide for coupling of SoC device 510 to peripherals, user input devices, user interface devices, printers, microphones, speakers, or other external devices and elements. In some examples, south bridge 530 includes a system management bus (SMB) controller or other system management controller elements.

Video interfaces 533 comprise various hardware and software elements for outputting digital images, video data, audio data, or other graphical and multimedia data which can be used to render images on a display, touchscreen, or other output devices. Digital conversion equipment, filtering circuitry, image or audio processing elements, or other equipment can be included in video interfaces 533.

Network interfaces 534 can provide communication between computing system 500 and other computing systems (not shown), which may occur over a communication network or networks and in accordance with various communication protocols, combinations of protocols, or variations thereof. Example networks include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof.

Computing system 500 can also comprise one or more enclosures 101 that can include various structural support elements, cases, chassis elements, or other elements that house and structurally support the further elements of computing system 500. Optional thermal management elements can include heatsinks, fans, heat pipes, heat pumps, refrigeration elements, or other elements to manage and control temperature of an optional enclosure and computing system 500. Typically, thermal management elements are included for SoC device 510 or associated circuitry. Thermal monitoring elements can include one or more temperature sensors comprising thermocouples, silicon bandgap temperature sensors, thermistors, resistance temperature detectors (RTDs), other temperature sensing elements.

Input power conditioning 550 can include filtering, surge protection, electromagnetic interference (EMI) protection and filtering, as well as perform other input power functions for input power 551. In some examples, input power conditioning 550 includes AC-DC conversion circuitry, such as transformers, rectifiers, power factor correction circuitry, or switching converters. When a battery source is employed as input power 551, then input power conditioning 550 can include various diode protection, DC-DC conversion circuitry, or battery charging and monitoring circuitry. Some of the elements of power system 540 might be included in input power conditioning 550.

As mentioned above, SoC device 510 includes many different internal elements and structures, such as processing cores 511, graphics cores 312, communication interfaces 513, memory interfaces 514, control core 520, e-fuses 521, and secure memory 522. However, each of these internal elements might be associated with a separate or dedicated power domain, or one or more of these internal elements might be serviced by multiple power domains. A power domain can comprise a set of power links, planes, distribution structures, or interconnect which is independent within SoC device 510 from other power domains. Power distribution structures of each power domain can receive input voltages having different voltage levels, which may be independently varied based on a voltage optimization process described herein. For example, processing cores 511 might all prefer a nominal input voltage level (VDD) of 1.00 VDC, but variations in this nominal input voltage level can be determined based on performance testing executed for SoC device 510. In such examples, individual processing cores 511 might be able to be operated at exemplary voltage levels such as 0.950 VDC, 0.925 VDC, or 0.900 VDC, among others. Other power domains can have other voltage levels determined.

Power system 540 includes a plurality of voltage regulator units 541-543. Power system 540 receives supply power over link 556 from input power conditioning circuitry 550. Link 556 can represent more than one voltage link or power link. Internal power distribution links can deliver power received over power link 556 to individual voltage regulator units 541-543. Voltage regulator units 541-543 individually alter voltage levels to produce input power for delivery to individual power domains of SoC device 510. SoC device 510 receives power over input power links 552-554 as supplied by the plurality of voltage regulator units 541-543.

Voltage regulator units 541-543 can provide supply voltages at associated current levels to SoC device 510. In many examples, each voltage adjustment unit can convert or alter a supply voltage of link 556 to a different output voltage on associated links 552-554, along with any related voltage regulation. Voltage regulator units 541-543 might receive supply power over link 556 at a first voltage level and convert this first voltage level into second voltage levels. These second voltage levels can be different among each of voltage regulator units 541-543, and each can correspond to a different power domain of SoC 530. Voltage regulator units 541-543 comprise various power electronics, power controllers, DC-DC conversion circuitry, power transistor gate modulation circuitry, power transistors, half-bridge elements, filters, passive components, and other elements to convert supply power received over link 556 into input power usable by SoC device 510.

Control core 520 can instruct voltage regulator units 541-543 over at least link 555 to provide particular voltage levels for one or more voltage domains of SoC device 510. Control core 520 can instruct voltage regulator units 541-543 to provide particular voltage levels for one or more operational modes, such as normal, standby, idle, and other modes. Control core 520 can receive instructions via external control link 558, which may comprise one or more programming registers, application programming interfaces (APIs), or other components. Control core 520 can provide status over link 558, such as temperature status, power phase status, current/voltage level status, or other information.

Control core 520 comprises a processing core separate from processing cores 511 and graphics cores 532. Control core 520 might be included in separate logic or processors external to SoC device 510 in some examples. Control core 520 typically handles initialization procedures for SoC device 510 during a power-on process or boot process. Thus, control core 520 might be initialized and ready for operations prior to other internal elements of SoC device 510. Control core 520 can comprise power control elements, such as one or more processors or processing elements, software, firmware, programmable logic, or discrete logic. Control core 520 can execute at least a portion of a voltage minimization process, voltage optimization process, or voltage characterization process for integrated circuit device 510. In other examples, control core 520 can include circuitry to instruct external power control elements and circuitry to alter voltage levels provided to integrated circuit device 510, or interface with circuitry external to SoC device 510 to cooperatively perform the voltage minimization process or voltage optimization process for integrated circuit device 510.

Control core 520 can comprise one or more microprocessors and other processing circuitry. Control core 520 can retrieve and execute software or firmware, such as firmware 560 comprising voltage control firmware, voltage monitoring firmware, and voltage optimization, minimization, or characterization firmware from an associated storage system, which might be stored on portions of storage system 531, RAM 532, or auxiliary memory 535. Control core 520 can be implemented within a single processing device but can also be distributed across multiple processing devices or sub-systems that cooperate in executing program instructions. Examples of control core 520 include general purpose central processing units, application specific processors, and logic devices, as well as any other type of processing device, combinations, or variations thereof. In some examples, control core 520 comprises a processing core separate from processing cores 511, a hardware security module (HSM), hardware security processor (HSP), security processor (SP), trusted zone processor, trusted platform module processor, management engine processor, microcontroller, microprocessor, FPGA, ASIC, application specific processor, or other processing elements. One example implementation of control core 520 is shown as control system 710 of FIG. 7, although variations are possible.

During power-on operations or boot operations, control core 520 instructs power system 540 to provide power to SoC device 510 according to voltage identifiers (VIDs) 523 and applies any offsets or margins determined from a voltage minimization process or voltage optimization process. These VID-indicated voltages can be indicated by e-fuses 521 or stored in data structures 524 in auxiliary memory 535, among other implementations. VIDs can be considered ‘default’ voltage levels that are typically specified according to a manufacturer specification or hard-coded by a manufacturer using electronic fuses (e-fuses) 521. In some examples, once VIDs 523 are set by a manufacturer, they cannot be altered by an operator or user of SoC device 510. VIDs 523 typically comprise a normalized value or encoded bits which are used to derive an actual voltage for driving SoC device 510.

Once at least control core 520 is powered on after receiving input power from power system 540 according to the VIDs, then control core 520 can read voltage offsets from data structures 524 in auxiliary memory 535 or secure memory 522. These voltage offsets are determined in a voltage minimization or optimization process, such as described in FIG. 2, and stored in auxiliary memory 535 or secure memory 522 for later usage. Example voltage offsets can indicate an incremental offset for a plurality of voltage or power domains, which can include positive or negative offsets. The voltage offsets might be stored in or secure memory 522 using a secure storage process, such as a digitally signed security process. A security process executed by control core 520 can authenticate the voltage offsets and ensure that tampering or alteration was not performed. The security process can include public-private key encryption techniques or other digital signature/authentication or data encryption techniques.

The voltage offsets 524 determined from the voltage minimization or optimization process can be stored into a memory device or data structure along with other corresponding information, such as time/date of the functional tests, version information for the functional tests, or other information. The version identifier can be used to provide special handling of results determined by different revisions of system 500. This data structure can be securely signed by a hardware security module (HSM) to ensure that the stored voltage information and related information is authentic. A digital signature for the data structure can be validated during each subsequent boot of SoC device 510, and used as the selected operational voltage for the remainder of any factory/manufacturing tests and subsequent user site operation.

Control core 520 can generate and maintain one or more data structures in secure memory using VIDs 523 and voltage offsets 524. This secure memory might include portions of memory 535 or secure memory 522, such as to include the various data structures. In some examples, control core 520 adds voltages that correspond to VIDs 523 to voltage offsets 524 to determine baseline operating voltage levels. Control core 520 can generate new VIDs which are stored in secure memory 522 which correspond to these baseline operating voltage levels, which can be generated on a per-voltage domain basis. These new VIDs can be presented to voltage regulator units 541-543 which responsively implement input voltages for SoC device 510 that correspond to the VIDs/offsets. Various margins or adjustments to the new VIDs or other voltage information can be made during operation of SoC device 510, such as to add additional margins, implement end-of-life (EoL) margins, or other features. In typical examples, only control core 520 can access secure memory 522, and processing cores 511 or graphics cores 512 cannot access or decrypt secure memory 522. Thus, a user-level application run in an operating system cannot typically directly modify VIDs/offsets. However, control core 520 might still receive requests from various software, drivers, hypervisors, or other elements to change VIDs responsive to user commands or other alteration inputs.

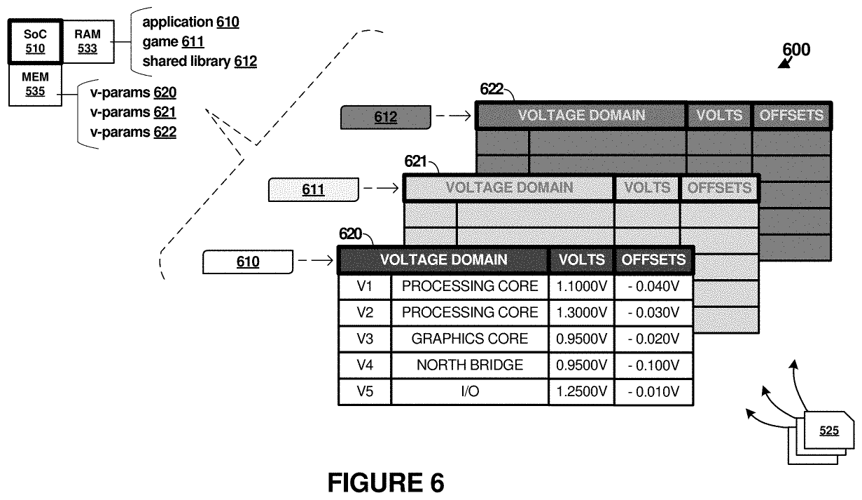

In addition to the power-on or initial boot of computing system 500 with regard to VIDs and voltage offsets determined from a voltage minimization or optimization process, further voltage adjustments can be made on-the-fly in response to execution of various software elements, such as applications, by processing cores 511 or graphics cores 512. FIG. 6 details example operations for per-software element voltage adjustment.

In FIG. 6, SoC device 510 can execute one or more portions of various software elements, such as application 610, game 611, and shared library 612, among other software elements discussed herein. These software elements can each have an identifier assigned thereto, which can be indicated by execution or processing elements of SoC device 510 to voltage control elements of SoC 510. For example, an operating system executed by processing cores 511 might indicate execution or anticipated execution of software elements to control core 520 using one or more communication interfaces, logical interfaces, application programming interfaces, or other interfaces. Control core 520 can receive indication of the software elements and retrieve voltage offsets 525 from auxiliary memory 535 or secure memory 522. These voltage offsets can be combined with a present operating voltage for one or more voltage domains of SoC device 510. A baseline operating voltage might be employed for each of the voltage domains as determined by a voltage minimization process along with any desired margins. Voltage offsets 525 can be added to/subtracted from these baseline operating voltages to determine net voltage levels to be applied to SoC device 510 by power system 540.

In FIG. 6, example voltage parameters 620 are shown which can be stored and retrieved in data structures 525 in memory 535. Voltage parameters 620 can comprise voltage offsets to be applied to one or more baseline operating voltages. An example table for voltage parameters 620 includes a first column indicating numerical identifiers for a particular voltage domain of SoC device 510 (V1-V5), a second column indicating descriptive identifier for the voltage domains, a third column indicating baseline operating voltages for the voltage domains, and a fourth column indicating voltage offsets for the voltage domains. The baseline operating voltage might be included in a separate data structure, such as data structure 524 in FIG. 5. Each of the voltage offsets can be applied to the baseline operating voltages to determine a voltage level to be applied to each voltage domain. Control core 520 can then determine control instructions for voltage regulation units of power system 540, such as VIDs or other representations of target voltage levels which are presented to selected voltage regulation units over link 555.

FIG. 7 illustrates control system 710 that is representative of any system or collection of systems from which the various performance testing, characterization, and voltage control operations can be directed. Any of the voltage control and control of testing or characterization employed in the operational architectures, platforms, scenarios, and processes disclosed herein may be implemented using elements of control system 710. In one implementation, control system 710 is representative of at least a portion of testing system 101 or voltage control system 125 of FIG. 1 or control core 520 of FIG. 5. Control system 710 might also include elements of an external system, such as a manufacturing system communicatively coupled to user system 110 of FIG. 1 or control core 520 of FIG. 5.

Control system 710 may be implemented as a single apparatus, system, or device or may be implemented in a distributed manner as multiple apparatuses, systems, or devices. Control system 710 includes, but is not limited to, processor 711, storage system 713, communication interface system 714, and firmware 720. Processor 711 is operatively coupled with storage system 713 and communication interface system 714.

Processor 711 loads and executes firmware 720 from storage system 713. Firmware 720 includes power control 721, which is representative of the processes discussed with respect to the preceding Figures and operations of FIGS. 2-4 and 6. When executed by processor 711 to enhance voltage control and voltage minimization or characterization for target integrated circuit devices, firmware 720 directs processor 711 to operate as described herein for at least the various processes, operational scenarios, and sequences discussed in the foregoing implementations. Control system 710 may optionally include additional devices, features, or functionality not discussed for purposes of brevity.

Referring still to FIG. 7, processor 711 may comprise a microprocessor and processing circuitry that retrieves and executes firmware 720 from storage system 713. Processor 711 may be implemented within a single processing device, but may also be distributed across multiple processing devices, sub-systems, or specialized circuitry, that cooperate in executing program instructions and in performing the operations discussed herein. Examples of processor 711 include general purpose central processing units, application specific processors, and logic devices, as well as any other type of processing device, combinations, or variations thereof.

Storage system 713 may comprise any computer readable storage media readable by processor 711 and capable of storing firmware 720. Storage system 713 may include volatile and nonvolatile, removable and non-removable media implemented in any method or technology for storage of information, such as computer readable instructions, data structures, program modules, or other data. Examples of storage media include random access memory (RAM), read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 713 may also include computer readable communication media over which at least some of firmware 720 may be communicated internally or externally. Storage system 713 may be implemented as a single storage device, but may also be implemented across multiple storage devices or sub-systems co-located or distributed relative to each other. Storage system 713 may comprise additional elements, such as a controller, capable of communicating with processor 711 or possibly other systems.

Firmware 720 may be implemented in program instructions and among other functions may, when executed by processor 711, direct processor 711 to operate as described with respect to the various operational scenarios, sequences, and processes illustrated herein. For example, firmware 720 may include program instructions for enhanced voltage control and voltage minimization or characterization for target integrated circuit devices, among other operations.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Firmware 720 may include additional processes, programs, or components, such as operating system software or other application software, in addition to that of firmware modules 722-727. Firmware 720 may also comprise program code, scripts, macros, and other similar components. Firmware 720 may also comprise software or some other form of machine-readable processing instructions executable by processor 711.

In general, firmware 720 may, when loaded into processor 711 and executed, transform a suitable apparatus, system, or device (of which control system 710 is representative) overall from a general-purpose computing system into a special-purpose computing system customized to facilitate enhanced voltage control and voltage minimization or characterization for target integrated circuit devices. Encoding firmware 720 on storage system 713 may transform the physical structure of storage system 713. The specific transformation of the physical structure may depend on various factors in different implementations of this description. Examples of such factors may include, but are not limited to, the technology used to implement the storage media of storage system 713 and whether the computer-storage media are characterized as primary or secondary storage, as well as other factors.

For example, if the computer readable storage media are implemented as semiconductor-based memory, firmware 720 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Firmware modules 722-727 can include one or more software elements, such as an operating system, devices drivers, and one or more applications. These elements can describe various portions of control system 710 with which voltage control elements, voltage optimization elements, or other elements interact. For example, an operating system can provide a software platform on which firmware modules 722-727 are executed and allows for enhanced voltage control and voltage optimization/minimization for target integrated circuit devices, among other operations.

When control system 710 comprises a testing or manufacturing system, such as testing system 101 of FIG. 1, voltage minimization service 726 can be included. In one example, voltage minimization service 726 determines one or more baseline levels of a supply voltage which are customized to an integrated circuit device by at least executing a performance test on the integrated circuit device to determine the baseline level as lower than a manufacturer specified voltage level for the supply voltage. Voltage minimization service 726 is configured to direct execution of a performance test on a target integrated circuit device to determine at least system performance over one or more incrementally adjusted input voltages for a target integrated circuit device with contextual elements. The performance test can be executed on each of a plurality of voltage domains of a target integrated circuit device determine minimum operating voltages lower than a manufacturer specified operating voltage for at least one input voltage. Transfer of the performance test to a target integrated circuit device can occur over link 770 or other links. The performance test can comprise computer-readable instructions stored within storage system 713. The performance test might comprise a system image or bootable image which includes an operating system, applications, performance tests, voltage regulator control instructions, and other elements which are transferred over link 770 to a target integrated circuit device under test.

In some examples, the performance test for a target integrated circuit device comprises iteratively booting the target integrated circuit device into an operating system after reducing a voltage level of at least one supply voltage applied to at least one voltage domain of the target integrated circuit device. For each reduction in the at least one supply voltage, the performance test includes executing a voltage characterization service to perform one or more functional tests that run one or more application level processes in the operating system and exercise processor core elements and interface elements of the target integrated circuit device in context with a plurality of elements external to the target integrated circuit device which share the at least one supply voltage. The performance test also includes monitoring for operational failures of at least the target integrated circuit device during execution of the voltage characterization service, and based at least on the operational failures, determining at least one resultant supply voltage, wherein the at least one resultant supply voltage relates to a power consumption for the target integrated circuit device. Iterative booting of the target integrated circuit device can comprise establishing a minimum operating voltage for the at least one supply voltage based on a current value of the iteratively reduced voltages, adding a voltage margin to the minimum operating voltage to establish the at least one resultant supply voltage, and via voltage regulator control 722, instructing voltage regulator circuitry of a voltage control system (such as voltage control system 125 of FIG. 1 or voltage regulator units 541-543 of power system 540 in FIG. 5) to supply the at least one resultant supply voltage to the target integrated circuit device for operation of the target integrated circuit device.

Voltage regulator control 722 includes elements which control voltage regulation or voltage adjustment circuitry of a voltage control system or voltage control circuitry. Voltage regulator control 722 can indicate target or desired voltage levels to be provided to one or more voltage domains of a target integrated circuit device, such as by instructing voltage control circuitry to alter voltage levels of one or more voltage regulator units, voltage regulator circuits, or voltage phases. Voltage regulator control 722 can receive input from voltage control circuitry which indicates present voltage levels, power consumption levels, temperature levels, or other metrics that indicate present operation of voltage control circuitry, voltage regulation circuitry, and target integrated circuit devices, among other elements. Voltage regulator control 722 can also control switching elements, switching logic, or transistor-level transfer elements which control flow of power to a target integrated circuit device or other elements in context with a target integrated circuit device.

When control system 710 comprises a testing or manufacturing system, such as testing system 101 of FIG. 1, voltage characterization service 727 can be included. Voltage characterization service 727 can determine voltage parameters or voltage offsets based at least on characterized performance of a plurality of software elements across one or more representative integrated circuit devices. Voltage characterization service 727 can perform one or more characterization tests across one or more user systems, SoC devices, or computing systems to determine voltage levels appropriate for various software elements, such as applications, games, and the like. Further examples of this testing is discussed in FIG. 3. A result of this characterization testing is that voltage parameters can be stored in one or more data structures for use by a computing system during operation. These data structures are shown as elements 730 in FIG. 7, and can be stored onto non-transitory computer readable media of a computing system.

Once operational, a computing system, such as computing system 510 of FIG. 5, can execute characterized software service 723. Characterized software service 723 receives an indication of one or more software elements selected for execution by an integrated circuit device, determines a target level of a supply voltage for the integrated circuit device based on the indication, and instructs voltage regulator control 722 to control voltage regulation circuitry and adjust a present level of the supply voltage for the integrated circuit device in accordance with the target level. Characterized software service 723 can process the indication against data structures 730 to determine the target level, where data structure 730 relates identities of a plurality of software elements to voltage offsets for adjustment from at least a baseline level of the supply voltage. Characterized software service 723 can determine the target voltage level by at least combining one or more voltage offsets with a baseline level of the supply voltage for the target integrated circuit device. Characterized software service 723 can determine a voltage identifier (VID) that represents the target voltage level, and transfer the VID to the voltage regulation circuitry via voltage regulator control 722 to adjust at least the supply voltages.

Uncharacterized software estimation service 724 can be employed when newly installed software elements are executed by an integrated circuit device which have not yet been characterized by voltage characterization service 727. Uncharacterized software estimation service 724 can receive indications comprising identifiers for software components or hardware components employed to execute one or more uncharacterized software elements. Uncharacterized software estimation service 724 can identify one or more corresponding voltage offsets which apply to the one or more uncharacterized software elements based at least in part on the identifiers for the software components or the hardware components. Uncharacterized software estimation service 724 can then combine the one or more corresponding voltage offsets to a baseline level of the supply voltage for the integrated circuit device to determine the target voltage level. Uncharacterized software estimation service 724 can determine a voltage identifier (VID) that represents the target voltage level, and transfer the VID to the voltage regulation circuitry via voltage regulator control 722 to adjust at least the supply voltages.

Control/status registers 725 include one or more non-volatile memory elements which provide status of the operation of control system 710 to external elements and system over link 770. Control over the operations of control/status registers 725 can also occur via modification or alteration of values stored within control/status registers 725, or of logic-coupled ones of control/status registers 725 which tie to operation of control system 710. Reads/writes of ones of control/status registers 725 can occur over link 770 from one or more external systems, which may include a target integrated circuit device among other control systems and manufacturing systems. Various example control registers might include performance testing alteration and initiation control registers, performance testing status registers, manual setting of operating voltage levels or minimum/maximum voltage levels, as well as various identification information comprising serial numbers, model numbers, version numbers, and related information for both hardware and software elements.

Communication interface system 714 may include communication connections and devices that allow for communication over link 770 to communicate with a target integrated circuit device, as well as with control electronics, voltage control systems, voltage adjustment circuitry, voltage adjustment units, power regulator circuitry, voltage control circuitry, power supply circuitry, or with external systems (not shown in FIG. 7) over one or more communication networks (not shown). Examples of connections and devices that together allow for inter-system communication may include discrete control links, system management buses, serial control interfaces, register programming interfaces, network interface cards, antennas, power amplifiers, RF circuitry, transceivers, and other communication circuitry. The connections and devices may communicate over communication media to exchange packetized communications with other computing systems or networks of systems, such as metal, glass, air, or any other suitable communication media. Communication interface system 714 may include user interface elements, such as programming registers, control/status registers 725, APIs, or other user-facing control and status elements.

Communication between control system 710 and other circuitry and systems (not shown in FIG. 7), may occur over link 770 comprising a communicate link or a communication network or networks, and in accordance with various communication protocols, combinations of protocols, or variations thereof. These other systems can include target integrated circuit devices, voltage control systems, or manufacturing systems, among others. Communication interfaces might comprise system management bus (SMB) interfaces, inter-integrated circuit (I2C) interfaces, or other similar interfaces. Further examples include intranets, internets, the Internet, local area networks, wide area networks, wireless networks, wired networks, virtual networks, software defined networks, data center buses, computing backplanes, or any other type of network, combination of network, or variation thereof. Some example communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof.

Certain inventive aspects may be appreciated from the foregoing disclosure, of which the following are various examples.

Example 1: A method, comprising receiving an indication of one or more software elements selected for execution by an integrated circuit device, determining a target level of a supply voltage for the integrated circuit device based on the indication, and controlling voltage regulation circuitry to adjust a present level of the supply voltage for the integrated circuit device in accordance with the target level.

Example 2: The method of Example 1, where the one or more software elements comprise at least one among an application, game, software container, virtual machine, software library, and device driver.

Example 3: The method of Examples 1-2, further comprising processing the indication against a data structure to determine the target level, where the data structure relates identities of a plurality of software elements to voltage offsets for adjustment from at least a baseline level of the supply voltage.

Example 4: The method of Examples 1-3, where the voltage offsets are determined based at least on characterized performance of the plurality of software elements across one or more representative integrated circuit devices.

Example 5: The method of Examples 1-4, further comprising determining the target level by at least combining one or more voltage offsets with a baseline level of the supply voltage for the integrated circuit device, determining a voltage identifier (VID) that represents the target level, and transferring the VID to the voltage regulation circuitry to adjust at least the supply voltage.

Example 6: The method of Examples 1-5, where the indication comprises identifiers for software components or hardware components employed to execute the one or more software elements, and further comprising identifying one or more corresponding voltage offsets which apply to the one or more software elements based at least in part on the identifiers for the software components or the hardware components, and combining the one or more corresponding voltage offsets to a baseline level of the supply voltage for the integrated circuit device to determine the target level.

Example 7: The method of Examples 1-6, where a baseline level of the supply voltage is customized to the integrated circuit device by at least executing a performance test on the integrated circuit device to determine the baseline level as lower than a manufacturer specified voltage level for the supply voltage.

Example 8: The method of Examples 1-7, where the performance test comprises iteratively booting the integrated circuit device into an operating system after reducing a present level of the supply voltage applied to the integrated circuit device. For each reduction in the present level of the supply voltage, the performance test includes executing a voltage characterization service to perform one or more functional tests that run one or more application level processes in the operating system and exercise processor core elements and interface elements of the integrated circuit device which share the supply voltage. The performance test includes monitoring for operational failures of at least the integrated circuit device during execution of the voltage characterization service, and determining the baseline level based at least on the operational failures.

Example 9: A voltage control system, comprising a communication interface configured to receive notifications of one or more software elements selected for execution by an integrated circuit device. The voltage control system includes a processing system configured to determine at least a target level for a supply voltage of the integrated circuit device based on the notifications, and control voltage regulation circuitry to adjust at least the supply voltage for the integrated circuit device in accordance with the target level.

Example 10: The voltage control system of Example 9, where the one or more software elements comprise at least one among an application, game, software container, virtual machine, software library, and device driver.

Example 11: The voltage control system of Examples 9-10, comprising the processing system configured to process the notifications against a data structure to determine the target level, where the data structure relates identities of a plurality of software elements to voltage offsets for adjustment of at least a baseline level of the supply voltage.

Example 12: The voltage control system of Examples 9-11, where the voltage offsets are determined based at least on characterized performance of the plurality of software elements across one or more representative integrated circuit devices.

Example 13: The voltage control system of Examples 9-12, comprising the processing system is configured to determine the target level by at least combining one or more voltage offsets with a baseline level of the supply voltage for the integrated circuit device, and determine a voltage identifier (VID) that represents the target level. The communication interface is configured to transfer the VID for delivery to the voltage regulation circuitry to adjust at least the supply voltage.

Example 14: The voltage control system of Examples 9-13, where the notifications comprises identifiers for software components or hardware components employed to execute the one or more software elements, and comprising the processing system configured to identify one or more corresponding voltage offsets which apply to the one or more software elements based at least in part on the identifiers for the software components or the hardware components, and combine the one or more corresponding voltage offsets with a baseline level of the supply voltage to determine the target level.

Example 15: The voltage control system of Examples 9-14, where the baseline level of the supply voltage is customized to the integrated circuit device by at least executing a performance test on the integrated circuit device to determine the baseline level as lower than a manufacturer specified voltage level for the supply voltage.

Example 16: The voltage control system of Examples 9-15, where the performance test comprises:

iteratively booting the integrated circuit device into an operating system after reducing a present level of the supply voltage applied to the integrated circuit device. For each reduction in the present level of the supply voltage, the performance test includes executing a voltage characterization service to perform one or more functional tests that run one or more application level processes in the operating system and exercise processor core elements and interface elements of the integrated circuit device which share the supply voltage. The performance test includes monitoring for operational failures of at least the integrated circuit device during execution of the voltage characterization service, and determining the baseline level based at least on the operational failures.

Example 17: A system-on-a-chip (SoC) device, comprising one or more processing cores configured to execute software elements, and a control core. The control core is configured to receive indications of target software elements to be executed by the one or more processing cores, determine, based at least in part on the indications, one or more target voltage levels for at least one voltage domain associated with the one or more processing cores, and indicate to voltage regulation circuitry to adjust voltage levels for the at least one voltage domain in accordance with the one or more target voltage levels.

Example 18: The SoC device of Example 17, where the target software elements comprise at least one among an application, game, software container, virtual machine, software library, and device driver.

Example 19: The SoC device of Examples 17-18, the control core further configured to receive the indications transferred by an operating system employed by the one or more processing cores to execute the target software elements, and process the indication against a data structure to determine the one or more target voltage levels, where the data structure relates identities of a plurality of software elements to voltage offsets for adjustment from at least a baseline voltage level. The control core is further configured to determine the one or more target voltage levels by at least combining one or more voltage offsets with the baseline voltage level for the at least one voltage domain, determine voltage identifiers (VIDs) that represent the one or more target voltage levels, and transfer the VIDs to the voltage regulation circuitry to adjust a present voltage level of the at least one voltage domain.

Example 20: The SoC device of Examples 17-19, where the voltage offsets are determined based at least on characterized performance of the plurality of software elements across one or more representative SoC devices, and where the baseline voltage level is customized to the SoC device by at least executing a performance test on the SoC device to determine the baseline voltage level as lower than a manufacturer specified voltage level for the at least one voltage domain.

The functional block diagrams, operational scenarios and sequences, and flow diagrams provided in the Figures are representative of exemplary systems, environments, and methodologies for performing novel aspects of the disclosure. The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method, comprising:
receiving an indication of one or more software elements selected for execution by an integrated circuit device;
determining a target level of a supply voltage for the integrated circuit device based on the indication; and
controlling voltage regulation circuitry to adjust a present level of the supply voltage for the integrated circuit device in accordance with the target level.

2. The method of claim 1, wherein the one or more software elements comprise at least one among an application, game, software container, virtual machine, software library, and device driver.

3. The method of claim 1, further comprising:
processing the indication against a data structure to determine the target level, wherein the data structure relates identities of a plurality of software elements to voltage offsets for adjustment from at least a baseline level of the supply voltage.

4. The method of claim 3, wherein the voltage offsets are determined based at least on characterized performance of the plurality of software elements across one or more representative integrated circuit devices.

5. The method of claim 1, further comprising:
determining the target level by at least combining one or more voltage offsets with a baseline level of the supply voltage for the integrated circuit device;
determining a voltage identifier (VID) that represents the target level; and
transferring the VID to the voltage regulation circuitry to adjust at least the supply voltage.

6. The method of claim 1, wherein the indication comprises identifiers for software components or hardware components employed to execute the one or more software elements, and further comprising:
identifying one or more corresponding voltage offsets which apply to the one or more software elements based at least in part on the identifiers for the software components or the hardware components; and
combining the one or more corresponding voltage offsets to a baseline level of the supply voltage for the integrated circuit device to determine the target level.

7. The method of claim 6, wherein a baseline level of the supply voltage is customized to the integrated circuit device by at least executing a performance test on the integrated circuit device to determine the baseline level as lower than a manufacturer specified voltage level for the supply voltage.

8. The method of claim 7, wherein the performance test comprises:
iteratively booting the integrated circuit device into an operating system after reducing a present level of the supply voltage applied to the integrated circuit device;
for each reduction in the present level of the supply voltage, executing a voltage characterization service to perform one or more functional tests that run one or more application level processes in the operating system and exercise processor core elements and interface elements of the integrated circuit device which share the supply voltage;
monitoring for operational failures of at least the integrated circuit device during execution of the voltage characterization service; and
determining the baseline level based at least on the operational failures.

9. A voltage control system, comprising:
a communication interface configured to receive notifications of one or more software elements selected for execution by an integrated circuit device;
a processing system configured to determine at least a target level for a supply voltage of the integrated circuit device based on the notifications, and control voltage regulation circuitry to adjust at least the supply voltage for the integrated circuit device in accordance with the target level.

10. The voltage control system of claim 9, wherein the one or more software elements comprise at least one among an application, game, software container, virtual machine, software library, and device driver.

11. The voltage control system of claim 9, comprising:
the processing system configured to process the notifications against a data structure to determine the target level, wherein the data structure relates identities of a plurality of software elements to voltage offsets for adjustment of at least a baseline level of the supply voltage.

12. The voltage control system of claim 11, wherein the voltage offsets are determined based at least on characterized performance of the plurality of software elements across one or more representative integrated circuit devices.

13. The voltage control system of claim 9, comprising:
the processing system configured to determine the target level by at least combining one or more voltage offsets with a baseline level of the supply voltage for the integrated circuit device;
the processing system configured to determine a voltage identifier (VID) that represents the target level; and
the communication interface configured to transfer the VID for delivery to the voltage regulation circuitry to adjust at least the supply voltage.

14. The voltage control system of claim 9, wherein the notifications comprises identifiers for software components or hardware components employed to execute the one or more software elements, and comprising:
the processing system configured to identify one or more corresponding voltage offsets which apply to the one or more software elements based at least in part on the identifiers for the software components or the hardware components; and
the processing system configured to combine the one or more corresponding voltage offsets with a baseline level of the supply voltage to determine the target level.

15. The voltage control system of claim 14, wherein the baseline level of the supply voltage is customized to the integrated circuit device by at least executing a performance test on the integrated circuit device to determine the baseline level as lower than a manufacturer specified voltage level for the supply voltage.

16. The voltage control system of claim 15, wherein the performance test comprises:
iteratively booting the integrated circuit device into an operating system after reducing a present level of the supply voltage applied to the integrated circuit device;
for each reduction in the present level of the supply voltage, executing a voltage characterization service to perform one or more functional tests that run one or more application level processes in the operating system and exercise processor core elements and interface elements of the integrated circuit device which share the supply voltage;
monitoring for operational failures of at least the integrated circuit device during execution of the voltage characterization service; and
determining the baseline level based at least on the operational failures.

17. A system-on-a-chip (SoC) device, comprising:
one or more processing cores configured to execute software elements; and
a control core configured to:
receive indications of target software elements to be executed by the one or more processing cores;
determine, based at least in part on the indications, one or more target voltage levels for at least one voltage domain associated with the one or more processing cores, and
indicate to voltage regulation circuitry to adjust voltage levels for the at least one voltage domain in accordance with the one or more target voltage levels.

18. The SoC device of claim 17, wherein the target software elements comprise at least one among an application, game, software container, virtual machine, software library, and device driver.

19. The SoC device of claim 17, the control core further configured to:
receive the indications transferred by an operating system employed by the one or more processing cores to execute the target software elements;
process the indication against a data structure to determine the one or more target voltage levels, wherein the data structure relates identities of a plurality of software elements to voltage offsets for adjustment from at least a baseline voltage level;
determine the one or more target voltage levels by at least combining one or more voltage offsets with the baseline voltage level for the at least one voltage domain;
determine voltage identifiers (VIDs) that represent the one or more target voltage levels; and
transfer the VIDs to the voltage regulation circuitry to adjust a present voltage level of the at least one voltage domain.

20. The SoC device of claim 19, wherein the voltage offsets are determined based at least on characterized performance of the plurality of software elements across one or more representative SoC devices; and
wherein the baseline voltage level is customized to the SoC device by at least executing a performance test on the SoC device to determine the baseline voltage level as lower than a manufacturer specified voltage level for the at least one voltage domain.
